(19) United States
(12) Patent Application Publication
(10) Pub. No.: US 2009/0300836 A1
(43) Pub. Date: Dec. 10, 2009

(54) STEAM BATH AND RESISTANCE SYSTEM EMPLOYED

(76) Inventor: Donato Antonio Padilla Rivas, San Cristobal (DO)

Correspondence Address: WOLF GREENFIELD & SACKS, P.C., 600 ATLANTIC AVENUE, BOSTON, MA, 02210-2206, US

(21) Appl. No.: 12/539,403

(22) Filed: Aug. 11, 2009

Related U.S. Application Data
(63) Continuation of application No. 11/563,026, filed on Nov. 23, 2006, now abandoned.

(30) Foreign Application Priority Data
Nov. 23, 2005 (DO) 2005000239

(51) Int. Cl. A61H 33/06

(52) U.S. Cl. 4/524

(57) ABSTRACT

Steam bath and steam bath type resistance system (5) employed, composed by three rectangular base prisms with open bases, placed one into the other where the two first prisms (1) and (2) generate 120 v and when third prism is placed (3) 240 v are generated at the same time. Such prisms are placed one into the other and separated by a special plastic or insulating material. This device is placed in a fiberglass container or case (16) and fixed to its base through a fastening system (6). No water is necessary for connection of this device to electricity. Water is introduced into the system by the drop (13) and application is regulated by a proportioning device (14) which will increase or decrease power consumption rate according with the number of water drops in contact with the resistance. Resistance system is used in a steam bath booth made of treated American wood or cedar and it is provided with a ventilation system (17), seat for one or two persons (18), refuse deposit (19), a reserve water deposit (20) and water inlet system (21).

### CROSS-REFERENCE TO RELATED APPLICATION

The present application claims the benefit, under 35 U.S.C. 120, as a continuation (CON) of U.S. non-provisional application Ser. No. 11/563,026, filed Nov. 23, 2006, entitled “Steam Bach and Resistance System Employed,” which application is incorporated herein by reference.

### FIELD OF THE INVENTION

This invention is related to a resistance system used for the generation of water steam, of the type used, as field of application, among others, in the manufacturing of steam baths. This device reduces power and water consumption, generating great amounts of steam necessary for this type of baths in quite a short time. Due to its characteristics, this device may be installed at residential houses, gyms, offices, etc.

### DESCRIPTION OF PREVIOUS ARTS

As everyone knows, steam baths are devices that have been used for a great number of years due to their medical properties, body relaxation qualities and, above all, for their special applications in the elimination of liquids and impurities from the body through sweat produced by the action of the water steam generated.

Solutions related to saunas, Turkish baths and steam baths are known in the state of the art in which energy is obtained from such sources as infrared, lights or lamps, preferably halogen lamps, and electric resistance, being the latter the most frequently used system and in particular, water steam generating calorific devices (resistances) are reported and known to have been employed in manufacturing of steam baths, and it is this aspect that present invention deals with.

U.S. Pat. No. 4,031,573 published on Jun. 28, 1077 filed by ROMANOFF PAUL IRA, shows a steam generating device consisting of an electric heater which generates enough heat to evaporate water in the tray that is placed over the heater. Main inconvenient posed by this device is that water evaporation process from the tray takes too long and this inevitably increases power consumption.

Patent JP 1118002 published on May 10, 1989 filed by YOOZEFU BARUTOHAAZARU ARUNORUT features a steam generator which can be used for steam baths. It has a resistance or heat element which is placed in the water in order to heat it to boiling point. The inconvenience of this device is that it takes high power consumption to convert water in steam and necessary time to accomplish this also increases.

Patent F1884726 published on May 14, 1990, filed by HELO TEHTAAT OY, features a system (electric stove) of the type used in steam baths provided with electric resistances which generate enough heat to evaporate water. However, this system also has the inconvenience of high power consumption since its temperature regulating system needs the incorporation of a great amounts of water in proportion to steam demands.

Patent F1884714 published on May 14, 1990, filed by HARVIA PERTI KALEVI, shows a resistance systems that works independently, that is, it does not need different voltage power, but it requires to be submerged in water, thus increasing water and power consumption and also significantly increases time needed in the process of heating water for its conversion to water steam.

Patent CH676199, published on Dec. 28, 1990, filed by KURZ RUDOLF GMBH & CO. features a device which main characteristic is that steam is obtained through the inmersion of a heater in a water deposit or tank. Generation of necessary steam requires high power consumption. The systems requiring introduction or submersion of heating devices in water pose the general inconvenience that the device has to be introduced cold in water so as to prevent that it breaks when it comes in contact with cold water. The generation of steam using this method requires high power consumption.

Patent DE4001778 published on Jul. 7, 1991, patent DE4226689 published on Feb. 17, 1994 and patent De 4328376 filed by DANNENMANN GUDRUM show a water steam generating device for steam baths. However, the inconvenience of this device is that the electric heating element is installed in the water tank and needs to heat all the water in the compartment for its conversion to steam and this requires time and necessarily increases power consumption.

Patent JP8199834 published on Aug. 6, 1996, filed by MITSUI MINING CO. LTD, features a resistance system that requires inmersion in water prior heating in order to evaporate water for its conversion to water steam and poses same inconveniences as devices included in above described patents.

Patent DE19609128 published on Nov. 9, 1007, filed by KLAFS SAUNBAU features a system that works under the principle of heating of a ceramic surface, which substitutes some other experiences in which different types of stone, preferably volcanic stones, are employed, but requires high power consumption for heating the ceramic surface and it does not allow the use of power of different voltages.

In patent JP2002272806 published on Sep. 24, 2002, filed by TANAKA YASUHIDE, a resistance system for generation of water steam is employed which features the inconvenience that the heating element has to be submerged in water prior to heating and this increases water and power consumption and there is a risk that the resistance will break if water deposit does not have the necessary amount of water when resistance is introduced. Likewise, systems operating submerged in water require a long time to convert water into steam by heating.

Patent DE10351263 published on Jun. 2, 2005, filed by RUKU GMBH & CO., KG features a steam generating unit for steam baths with a container which is filled with water which is evaporated by use of a heating element. A high power consumption is required for this heating unit (which is not located inside the container but underneath) to generate enough heat to convert water into steam.

In General, Turkish baths included in present state of the art show general inconveniences as follows:

a) Existing and known resistances for the generation of steam are generally submerged in a water containers or deposits which are fed through a continues flow of water or, on the contrary, via communicating vases, allowing resistance to be connected to water to avoid overheating when getting red hot through contact with electricity and prevent breakage when water is incorporated.

b) The fact that the device is submerged in a container permanently containing water increases time for water to reach required temperature to convert water into steam.

c) Due to the fact that the heating element is submerged in a water container, if amperage rating is 25, the device will reach its maximum ampere capacity as soon as it comes in contact with water, thus producing a continues high power consumption.

d) For the above mentioned traditional systems to be connected to 120 v to 240 v a current adaptor is required. Otherwise, the device will sustain damage.

e) These systems must be connected with water and have adequate grounding and generally has to be connected to 240 v due to the high amperage required by the device.

As everyone knows, most of the end-users of these devices do not afford enough time for a steam bath and systems which would allow them to take a quick and effective steam bath with low power and water consumption at their offices, gyms or at home would be a solution in their practical and economic aspects. This kind of solution is not included in present state of the art.

### SUMMARY

Steam bath and steam bath type resistance system (5) employed, composed by three rectangular base prisms with open bases, placed one into the other where the two first prisms (1) and (2) generate 120 v and when third prism is placed, (3) 240 v are generated at the same time. Such prisms are placed one into the other and separated by a special plastic or insulating material. This device is placed in a fiberglass container or case (16) and fixed to its base through a fastening system (6). No water is necessary for connection of this device to electricity. Water is introduced into the system by the drop (13) and application is regulated by a proportioning device (14) which will increase or decrease power consumption rate according with the number of water drops in contact with the resistance. Resistance system is used in a steam bath booth made of treated American wood or cedar and it is provided with a ventilation system (17), seat for one or two persons (18), refuse deposit (19), a reserve water deposit (20) and water inlet system (21).

### DESCRIPTION OF THE INVENTION

The object of this invention consists of a resistance system for the production of steam which can be used in steam baths with a maximum performance as far as energy and water consumption is concerned.

Figures show:

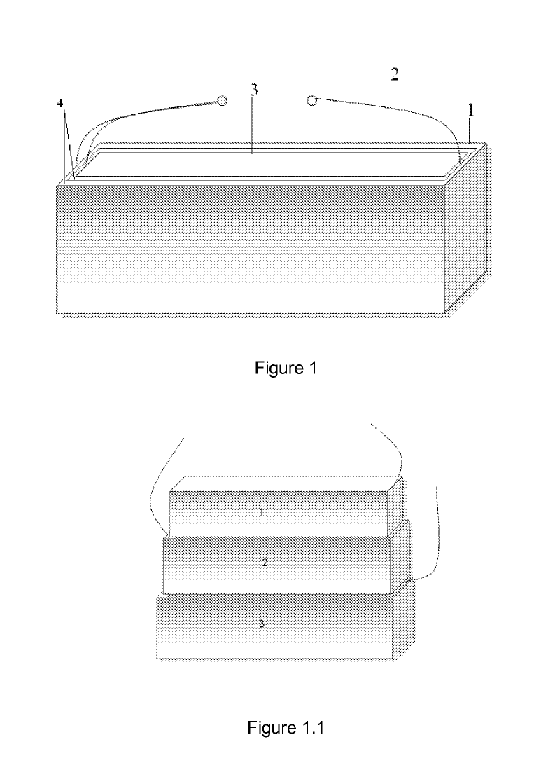

FIG. 1 shows a side view of the resistance system;

FIG. 1.1 shows a raised view of the system;

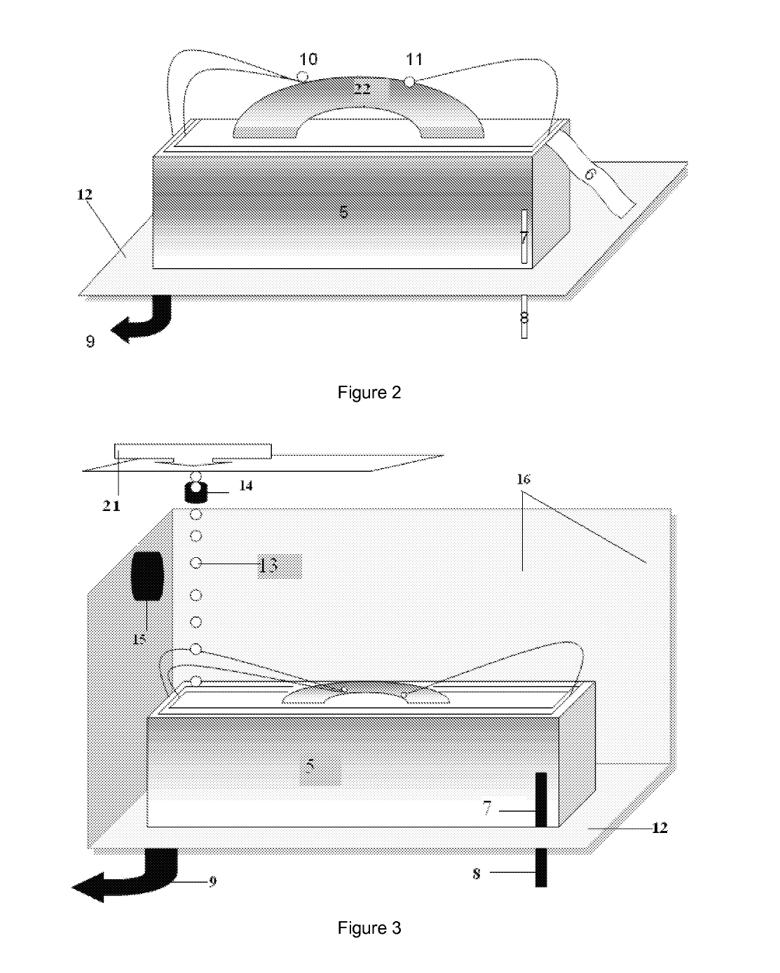

FIG. 2 shows a view of the resistance system, base for the electrical poles and fastening system;

FIG. 3 shows a full view of the resistance system and the water dripping system; and

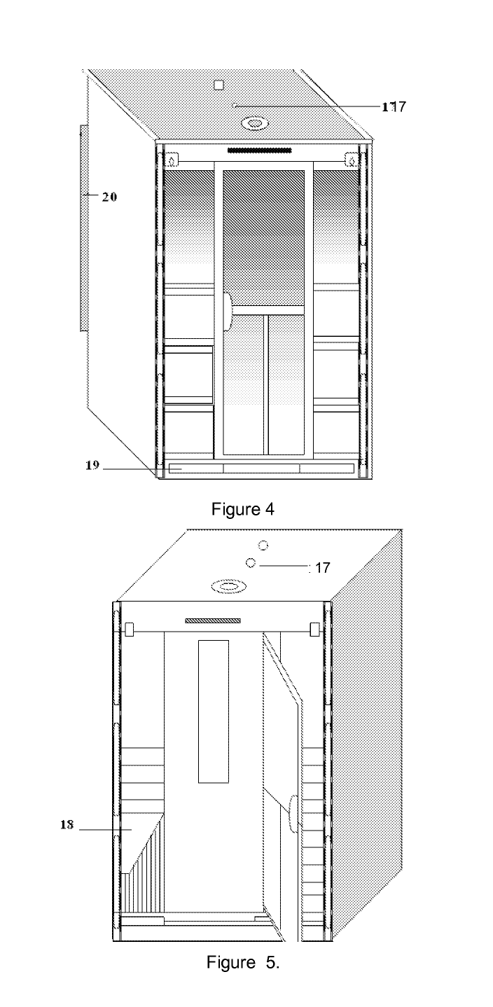

FIGS. 4 and 5 show a diagonal view of the booth or steam bath.

Resistance system in question is made up by 3 rectangular base prisms, with open bases, consisting of different dimensions stainless steel sheets (1), (2) and (3), as shown in FIGS. 1 and 1.1 bent in rectangular shape, forming rectangular prisms, allowing the first two (1) and (2) prisms to generate 120 v and a third prism which generates 240 v at the same time.

Such rectangular prisms are placed one inside the other and must be separated by a special plastic or insulating material (4), and have a base (22) for electrical poles (10) and (11).

These resistances are placed in a fiberglass case or container (16) which has water inlet (21), steam outlet (15), manual drain and gravity and automatic water control system.

The resistance system for the production of water steam has following advantages over those systems known in present state of the art:

1. The device can be dry-connected without the risk that the resistance, after, heating, fragments when coming in contact with water.

2. In spite of being made from stainless steel, the resistance never gets red-hot with electricity, which permits resistance walls to be durable.

3. Water application is by the drop and controlled by a device which will increase or decrease power consumption, depending on the number of drops in contact with the resistance and the decreasing speed rate of the drops. This will result in savings of water since a permanent water container is not needed.

4. Time saving in the generation of steam, since one or more water drops evaporate becoming water steam faster than water accumulated in a container.

5. The fact that the resistance can be dry-connected to electricity (without water), will allow that the amperage will start from 0 and as the number of water drops is introduced into the system, the amperage will gradually go up until reaching between 8 and 10 (maximum) at 120 v and since the resistance can be connected to 240 v, the amperage will drop to 3 or 4 amperes.

This water steam generating device is employed in a cedar or American treated pine steam bath. This steam bath is provided with: Ventilation system (17), lighting, aromatic essence compartment, seats for one or two persons (18), automatic drain, refuse deposit (19), and reserve water deposit (20) to be applied to the system by the drop.

Manufacturing features that allow this invention to be brought to practical purposes are shown as an illustrative, but no limitative example, as follows:

A resistance made up by three rectangular base prisms with open bases made of stainless steel 24 gauge sheets, where the sheet that forms the outside rectangular base prism (3) has dimensions of 16.5 cm long .times.5.5 cm wide .times.4.2 cm high; the sheet that make up the intermediate rectangular base prism (2) measures 15.5 cm long .times.5.0 cm wide .times.4.2 high, and the inside rectangular base prism (1) has 15 cm long .times.4.5 cm wide .times.4.2 cm high These rectangular base prisms must be separated one from the other by a special plastic or insulating material (4).

This device is placed in a fiberglass container or case (16) which measures 7½″ long .times.3″ wide .times.5″ high, and is has a water inlet (21) provided with a discharge pipe in a proportioning device (14) for water dripping (13), a steam outlet (15) connected to the booth, manual drain, and an automatic and gravity water control system.

Dimensions of a booth made of cedar or American treated pine for one person are 80″ high .times.37″ wide .times.30″ depth.

The device is plugged to electricity for use and immediately starts generating water steam through water drops falling on the resistance. If desired, some aromatic essence may be added to water for the pleasure of the person using the steam bath.

Another potential manufacturing feature of the system would consist of three (3) cylinders or cubes made of the same stainless steel material which could be made of different sizes or configurations so as to place them ones into the others and separate them with an insulating material. To accomplish this it would also be necessary to adapt the fiberglass case (16) to the new configuration presented by the resistance system and employ same technical rule for the water dripping system.

1. Steam bath and steam bath type resistance system employed for the generation of water steam with the characteristic that it is composed by three rectangular base placed one into the other where the two first prisms (1) and (2) generate 120 v and when third prism is placed (3) 240 v are generated at the same time.
